(19) United States
(12) Patent Application Publication
(10) Pub. No.: US 2026/0066401 A1
(43) Pub. Date: Mar. 5, 2026

(54) FOLDING PROCESSING APPARATUS FOR BATTERY CELL AND BATTERY CELL MANUFACTURING METHOD USING THE SAME

(71) Applicant: SK ON CO., LTD., Seoul (KR)

(72) Inventors: Ju Heon LEE, Daejeon (KR); Yoo Seok JEONG, Daejeon (KR)

(21) Appl. No.: 19/315,693

(22) Filed: Sep. 1, 2025

(30) Foreign Application Priority Data
Sep. 4, 2024 (KR) 10-2024-0120000

(51) Int. Cl. H01M 50/105; H01M 10/04

(52) U.S. Cl. CPC H01M 50/105; H01M 10/0404

(57) ABSTRACT

A folding processing apparatus for a battery cell includes a first guide member defining a first folding line on a first surface of a sealing portion of a battery cell, a second guide member defining a second folding line on the first surface of the sealing portion, a first bending member defining the first folding line on a second surface of the sealing portion and bending the sealing portion along the second folding line, and a second bending member bending the sealing portion by 180 degrees along the first folding line.

### CROSS-REFERENCE TO RELATED APPLICATION(S)

This patent document claims the priority and benefits of Korean Patent Application No. 10-2024-0120000 filed on Sep. 4, 2024, the disclosure of which is incorporated herein by reference in its entirety.

### TECHNICAL FIELD

The disclosure and implementations disclosed in this patent document generally relate to a folding apparatus for folding processing a sealing portion of a pouch-type battery cell and a battery cell manufacturing method using the folding apparatus.

### BACKGROUND

Unlike primary batteries, secondary batteries may be charged with and discharged of electricity, and thus, may be applied to devices within various fields, including digital cameras, mobile phones, laptops, hybrid vehicles, and electric vehicles. Examples of secondary batteries include nickel-cadmium batteries, nickel-metal hydride batteries, nickel-hydrogen batteries, and lithium secondary batteries.

Among such secondary batteries, extensive research has been conducted into lithium secondary batteries having high energy density and discharge voltage. Recently, lithium secondary batteries have been manufactured as flexible pouch-type battery cells or rigid prismatic or cylindrical can-type battery cells.

Thereamong, in pouch-type battery cells, a space is formed within a film casing to accommodate an electrode assembly and at least a portion of the perimeter of the electrode assembly is sealed to form a sealing portion. An electrode lead is connected to the electrode assembly and is exposed externally through the sealing portion. A portion of the sealing portion, in which the electrode lead is not disposed, is folded to increase sealing reliability and to minimize the volume occupied by the sealing portion.

### SUMMARY

The present disclosure may be implemented in some embodiments to perform an operation of folding of a sealing portion of a pouch-type battery cell rapidly, thereby reducing the manufacturing time of the battery cell.

Battery cells manufactured through the present disclosure may be widely applied in green technology fields, such as electric vehicles, battery charging stations, and solar power generation and wind power generation using batteries. In addition, the battery cells manufactured through the present disclosure may be used in eco-friendly electric vehicles and hybrid vehicles to prevent a climate change by suppressing air pollution and greenhouse gas emissions.

In some embodiments of the present disclosure, a folding processing apparatus for a battery cell includes: a first guide member defining a first folding line on a first surface of a sealing portion of a battery cell; a second guide member defining a second folding line on the first surface of the sealing portion; a first bending member defining the first folding line on a second surface of the sealing portion and bending the sealing portion along the second folding line; and a second bending member bending the sealing portion by 180 degrees along the first folding line.

The second bending member may firstly bend the sealing portion, while moving in a first direction, a thickness direction of the battery cell, and secondly bend the sealing portion, while moving in a second direction, a surface direction of the battery cell.

The first bending member may bend the sealing portion, while moving in the first direction.

The first guide member may be disposed to be movable linearly in the first direction and to be rotatable, in a third direction, orthogonal to the first direction and the second direction, as an axis.

The first guide member may include: a first frame disposed parallel to the second direction; a second frame extending from the first frame toward the battery cell; and a third frame extending from the second frame to form an acute angle with the sealing portion, an end of the third frame contacting the sealing portion to define the first folding line.

A rotational axis of the first guide member may be formed in the first frame.

The first bending member and the second bending member may respectively include a heat source applying heat to the sealing portion.

The second bending member may include: a first surface disposed parallel to the first direction; and a second surface and a third surface extending from the first surface and disposed parallel to the second direction, wherein the first surface, the second surface, and the third surface may be formed as flat planes, and a chamfered surface may be formed at a corner portion at which the first surface and the second surface meet.

An inclination angle of the chamfered surface with respect to the second direction may be formed to be equal to or greater than an inclination angle of the third frame.

A corner portion at which the first surface and the third surface meet may be formed as a chamfered surface or a curved surface.

The second guide member may be disposed between the first guide member and a cell body of the battery cell, and a first surface of the second guide member facing the first guide member may be formed as a plane, parallel to the first surface of the second bending member.

In some embodiments of the present disclosure, a folding processing apparatus for a battery cell includes: a first guide member disposed to be linearly and rotatably movable and pressing a first folding line of a sealing portion of a battery cell on a first surface of the sealing portion; a first bending member disposed on a second surface of the sealing portion and supporting the sealing portion; and a second bending member firstly bending the sealing portion, while moving in a first direction, a thickness direction of the battery cell, and secondly bending the sealing portion, while moving in a second direction, a surface direction of the battery cell, wherein the first guide member supports the first folding line, while the second bending member moves in the first direction, and when the second bending member moves in the second direction, the first guide member rotates to be separated from the sealing portion.

The folding processing apparatus may further include: a second guide member pressing a second folding line of the sealing portion on the first surface of the sealing portion, wherein the first bending member bends the sealing portion along the second folding line, while moving in the first direction.

In some embodiments of the present disclosure, a battery cell manufacturing method includes: a first operation in which a first guide member presses a first surface of a sealing portion of a battery cell and a first bending member presses a second surface of the sealing portion to define a first folding line; a first bending operation in which a second bending member bends the sealing portion along the first folding line, while moving in a first direction, a thickness direction of the battery cell; a second bending operation in which the second bending member bends the sealing portion along the first folding line, while moving in a second direction, a surface direction of the battery cell; and a third bending operation in which the first bending member bends the sealing portion, while moving in the first direction along a second folding line defined by a second guide member.

The battery cell manufacturing method may further include: after the second bending operation, an operation in which the first bending member and the second bending member thermally press the sealing portion in the first direction.

The battery cell manufacturing method may further include: after the third bending operation, an operation in which the second bending member thermally presses the sealing portion in the second direction.

In the second bending operation, when the second bending member moves in the second direction, the first guide member may rotate to be separated from the sealing portion.

The first bending operation may be an operation of bending the sealing portion by 90 degrees from an initial state and the second bending operation may be an operation of bending the sealing portion by 180 degrees from the initial state.

In some embodiments of the present disclosure, a battery cell folding method, as a method of folding a shark fin of a battery cell, includes: an operation in which a guide member disposed on a first surface side of the shark fin contacts the shark fin to define a folding line; an operation in which a first bending member disposed on a second surface side of the shark fin moves in a first direction, a thickness direction of the battery cell, to bend the shark fin; and an operation in which a second bending member thermally presses the bent shark fin, while moving in a second direction, a surface direction of the battery cell.

### BRIEF DESCRIPTION OF DRAWINGS

Certain aspects, features, and advantages of the present disclosure are illustrated by the following detailed description with reference to the accompanying drawings.

FIG. 1 is a schematic diagram illustrating the shape of a pouch-type battery cell before folding;

FIG. 2 is a schematic diagram sequentially illustrating an example of the shape change of a sealing portion of the pouch-type battery cell illustrated in FIG. 1 taken along line I-I′ of FIG. 1 during folding processing;

FIG. 3 is a side view schematically illustrating a battery cell folding apparatus according to the present embodiment;

FIGS. 4 to 12 are diagrams illustrating a folding method using the folding apparatus illustrated in FIG. 3;

FIG. 13 is a flowchart illustrating a folding method using the folding apparatus illustrated in FIG. 3;

FIG. 14 is a partially enlarged view of portion A of FIG. 1;

FIGS. 15 to 17 are diagrams illustrating a shark fin folding method using the folding apparatus illustrated in FIG. 3; and

FIG. 18 is a flowchart illustrating a shark fin folding method using the folding apparatus illustrated in FIG. 3.

### DETAILED DESCRIPTION

Hereinafter, the present disclosure will be described in detail with reference to the accompanying drawings. However, this is merely an example and the present disclosure is not limited to the specific embodiments described as examples.

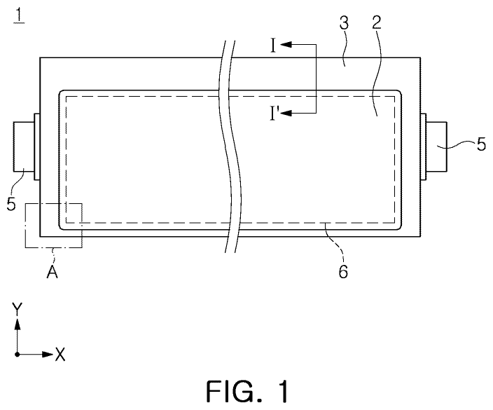

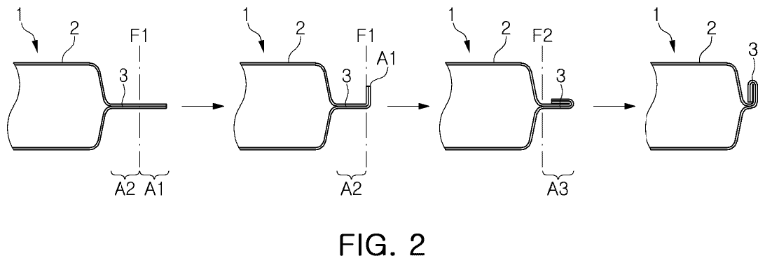

First, a pouch-type battery cell 1 manufactured according to the present disclosure will be described with reference to FIGS. 1 and 2.

FIG. 1 is a schematic diagram illustrating the shape of a pouch-type battery cell before folding, and

FIG. 2 is a schematic diagram sequentially illustrating an example of the shape change of a sealing portion of the pouch-type battery cell illustrated in FIG. 1 taken along line I-I′ of FIG. 1 when the sealing portion of the pouch-type battery cell illustrated in FIG. 1 is folded and processed.

Referring to FIGS. 1 and 2, the pouch-type battery cell 1 may include a cell body 2 accommodating an electrode assembly 6 therein and a sealing portion 3 sealing at least a portion of the periphery of the cell body 2 to isolate the electrode assembly 6 from the outside. The sealing portion 3 may be formed on a flange-shaped portion exposed on the outside of the cell body 2. An electrode lead 5 is connected to the electrode assembly 6 and is exposed to the outside through a portion of the sealing portion 3.

The pouch-type battery cell 1 illustrated in FIG. 1 is illustrated as an example in which a single sheet of film casing is folded to form the cell body 2 and the sealing portion 3. In this case, the sealing portion 3 may be formed on three sides of the cell body 2 (the upper side and the left and right sides of the cell body in FIG. 1).

However, the structure of the sealing portion 3 of the pouch-type battery cell 1 applied to the present disclosure is not limited thereto. For example, in the pouch-type battery cell 1, the cell body 2 and the sealing portion 3 may be formed by bonding two sheets of film casing, in which case the sealing portion 3 may be formed on four sides of the cell body 2.

The sealing portion 3 may be folded to increase bonding reliability of a sealed portion and minimize the volume occupied by the sealing portion 3. That is, at least a portion of the a plurality of sealing portions 3 may be folded at least once. For example, the sealing portion 3 located in a portion in which the electrode lead 5 is not disposed may be folded at least once.

Referring to FIG. 2, the sealing portion 3 of the pouch-type battery cell 1 undergoes at least one folding process to have a folding structure folded at a specific angle. For example, when a state (hereinafter, “initial state”) of the sealing portion prior to folding is defined as 0 degrees, the sealing portion 3 may be folded approximately 90 degrees in an outer region (A1, hereinafter, a “first region”) with respect to a first folding line F1 during a first folding process and the first region A1 may be folded again by 90 degrees during a second folding process. Therefore, after the second folding process is completed, the first region A1 may be folded by 180 degrees based on the initial state of the sealing portion 3. Furthermore, the sealing portion 3 may be folded by 90 degrees further in an outer region (A3, hereinafter, a “third region”) with respect to a second folding line F2 in a third folding process. In this case, the first region A1 may be folded by 270 degrees based on the initial state of the sealing portion 3 and, ultimately, the first region of the sealing portion 3 may be disposed adjacent to a sidewall of the cell body 2.

In the present embodiment, the folding process for the sealing portion 3 may correspond to any one of the first to third folding processes described above. However, in the present embodiment, the folding process for the sealing portion 3 is not limited to a process of folding at a specific angle, such as 90 degrees, 180 degrees, or 270 degrees. In addition, the number of performing the folding process may be changed variously from one to several.

In this manner, the folding angle for the sealing portion 3 and the number of performing the folding process may vary depending on the final specifications of the battery cell 1. Furthermore, the folding process for the sealing portion 3 may be performed using a folding apparatus 10, described below.

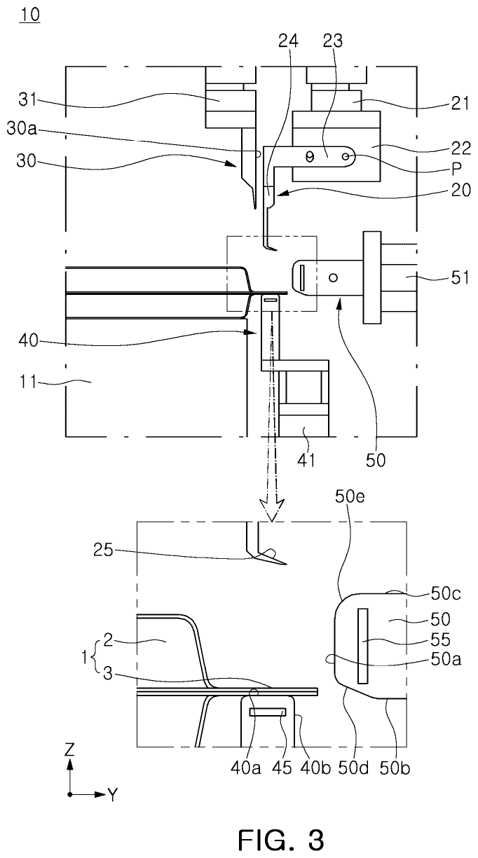

FIG. 3 is a side view schematically illustrating a battery cell folding apparatus according to the present embodiment.

Referring also to FIG. 3, the battery cell folding apparatus 10 according to the present embodiment may include a first guide member 20 defining the first folding line F1 on a first surface of the sealing portion 3 of the battery cell 1, a second guide member 30 defining the second folding line F2 on the first surface of the sealing portion 3, a first bending member 40 defining the first folding line F1 on a second surface of the sealing portion 3 and bending the sealing portion 3 along the second folding line F2, and a second bending member 50 bending the sealing portion 3 by 180 degrees along the first folding line F1. In addition, the bell cell folding apparatus 10 may include a mounting portion 11 on which the battery cell 1 is mounted so that the sealing portion 3 of the battery cell 1 protrudes outwardly.

In addition, the folding apparatus 10 of the present embodiment includes the first guide member 20 disposed to be linearly moved and rotatably moved and pressing the first folding line F1 of the sealing portion 3 on the first surface of the sealing portion 3 of the battery cell 1, the first bending member 40 disposed on the second surface of the sealing portion 3 and supporting the sealing portion 3, and the second bending member 50 moving in a first direction, a thickness direction of the battery cell 1, to firstly bend the sealing portion 3 and moving in a second direction, a surface direction of the battery cell 1, to secondly bend the sealing portion 3. The first guide member 20 supports the first folding line F1, while the second bending member 50 moves in the first direction, and may rotate to be separated from the sealing portion 3 when the second bending member 50 moves in the second direction.

In the following description, the first surface of the battery cell 1 or sealing portion 3 may refer to an upper surface of the battery cell 1 illustrated in FIG. 3 and the second surface of the battery cell 1 or sealing portion 3 may refer to a lower surface of the battery cell 1 illustrated in FIG. 3.

In addition, in the following description, the first direction may refer to the thickness direction of the battery cell 1 (the Z-axis direction or an up-down direction in FIG. 3), and the second direction may refer to a direction in which the sealing portion 3 protrudes from the cell body 2 of the battery cell 1, i.e., the surface direction or width direction of the battery cell 1 (the Y-axis direction or a left-right direction in FIG. 3). Furthermore, a third direction may refer to a length direction of the battery cell 1 (the X-axis direction or a left-right direction in FIG. 1). Furthermore, the first to third directions may respectively include both positive (+) and negative (−) directions of the corresponding direction.

The mounting portion 11 is the portion on which the battery cell 1 is mounted during the process of folding the sealing portion 3 of the battery cell 1 and may include a flat surface supporting the lower surface of the battery cell 1. When the battery cell 1 is mounted on the mounting portion 11, the sealing portion 3 of the battery cell 1 may protrude outwardly from the mounting portion 11. Therefore, the mounting portion 11 may not be disposed in a region facing the sealing portion 3 of the battery cell 1.

In the following description, the positions of each component are described based on the battery cell 1 mounted on the mounting portion 11. Therefore, unless otherwise specified, the battery cell 1 mentioned in the following description refers to the battery cell 1 mounted on the mounting portion 11, as illustrated in FIG. 3.

The first bending member 40 may be disposed below the sealing portion 3, the second surface of the battery cell 1. The first bending member 40 may be disposed to be movable in a reciprocating manner in the first direction (the Z-axis direction), the thickness direction of the battery cell 1. To this end, the first bending member 40 may be connected to a first moving device 41 moving the first bending member 40. The first moving device 41 may be any known device capable of linearly reciprocating the first bending member 40 in the first direction, such as a linear motor, a hydraulic/pneumatic cylinder, or a robot arm.

The first bending member 40 may be formed in a block shape and a first surface 40a facing the sealing portion 3 may be formed as a flat surface parallel to the sealing portion 3.

The first bending member 40 may include a heat source applying heat to the sealing portion 3. For example, a first heat source 45 may be disposed on the first surface 40a of the first bending member 40. The first heat source 45 may heat a region in the vicinity of the first surface 40a of the first bending member 40, and to this end, the first heat source 45 may include a heat-generating heater.

A second surface 40b of the first bending member 40 may also be formed as a flat surface. The second surface 40b of the first bending member 40 extends from the first surface 40a and may be disposed parallel to a plane defined by the first direction (the Z-axis direction) and the third direction (the X-axis direction). The second surface 40b of the first bending member 40 may refer to a right surface of the first bending member 40, orthogonal to the first surface 40a of the first bending member 40 in FIG. 3.

The second surface 40b of the first bending member 40 may be disposed parallel to the first surface 50a of the second bending member 50, which will be described below. Furthermore, the second surface 40b of the first bending member 40 may be disposed along the first folding line F1, which is a fold line of the sealing portion 3.

Accordingly, the first bending member 40 may be disposed between the cell body 2 and the first folding line F1, and as a result, a width of the first bending member 40 may be less than a distance between the cell body 2 and the first folding line F1. Here, the width of the first bending member 40 and the width of the sealing portion 3 may refer to a distance in the second direction (the Y-axis), which is the width direction of the battery cell 1.

The first bending member 40 may contact the sealing portion 3 to bend the sealing portion 3. For example, the first bending member 40 may move in the first direction (the Z-axis direction) and bend the sealing portion 3 along the second folding line F2. In an embodiment, the first bending member 40 may bend the third region (A3 in FIG. 2) by 90 degrees along the second folding line F2.

Furthermore, the first bending member 40 may press the bent sealing portion 3 and apply heat to the bent region, thereby thermally pressing the sealing portion 3. For example, the first bending member 40 and the second bending member 50 may thermally press the bent sealing portion 3 along the first folding line F1.

The first guide member 20 may be disposed above the sealing portion 3, which is the first surface of the battery cell 1. The first guide member 20 may be disposed to be linearly movable in the first direction and rotatable about the third direction (the X-axis direction) as an axis. Here, the third direction (the X-axis direction) may be the length direction of the battery cell 1 or a direction, orthogonal to the first direction (the Z-axis direction) and the second direction (the Y-axis direction).

To this end, the first guide member 20 may be connected to a second moving device 21 moving the first guide member 20. The second moving device 21 may include a linear motor, a hydraulic/pneumatic cylinder, a robot arm, or the like to reciprocate the first guide member 20 linearly in the first direction and may also include a rotational driving device, such as a rotational motor, to rotate the first guide member 20 in the second direction. In addition, the second moving device 21 may include a linearly moving bracket 22, and the first guide member 20 may be rotatably coupled to the bracket 22 via the rotational driving device.

The first guide member 20 may include a first frame 23 disposed parallel to the second direction (the Y-axis direction), a second frame 24 extending from the first frame 23 toward the battery cell 1, and a third frame 25 extending from the second frame 24 to form an acute angle with the sealing portion 3 and having an end in contact with the sealing portion 3 to define the first folding line F1. A rotational axis P of the first guide member 20 may be formed in the first frame 23.

The first frame 23 may be rotatably coupled to the aforementioned bracket 22. The rotational axis P of the first guide member 20 may be disposed parallel to the third direction (the X-axis) and may be disposed at the end portion of the first frame 23 with respect to the first direction. In this case, the rotational axis P may be disposed at a position not facing the sealing portion 3. For example, the rotational axis P may be disposed at a position spaced apart from the battery cell 1 at a predetermined distance in the second direction. However, the present embodiment is not limited thereto.

The second frame 24 may extend from the first frame 23 toward the battery cell 1 or the first bending member 40. The second frame 24 may be disposed to face the sealing portion 3 of the battery cell 1. Accordingly, the second frame 24 may extend from the region of the first frame 23 facing the sealing portion 3 and the end portion of the second frame 24 may be disposed to be spaced apart from the sealing portion 3 at a predetermined distance.

The third frame 25 may extend obliquely from the end portion of the second frame 24, and the end of the third frame 25 may contact the sealing portion 3. Here, the third frame 25 and the sealing portion 3 in an initial state thereof may form an acute angle.

In the present embodiment, the third frame 25 may be formed in a wedge shape, with the thickness gradually decreasing toward the end. Therefore, the end of the third frame 25 may be formed to be sharp.

During the folding process, the first guide member 20 may descend portion in the first direction and come into contact with the sealing portion 3. Here, the end of the third frame 25 may press against the sealing portion 3 to form the first folding line F1. For example, a pressure line along which the end of the third frame 25 presses against the sealing portion 3 may be formed as the first folding line F1.

Furthermore, when the first guide member 20 rotates about the aforementioned rotational axis P, the first guide member 20 may rotate in a direction in which the third frame 25 is closer to or away from the cell body 2.

The second guide member 30 may be disposed above the sealing portion 3. The second guide member 30 may be disposed approximately parallel to the first guide member 20 and may be disposed between the first guide member 20 and the cell body 2 of the battery cell 1. Furthermore, a first surface 30a of the second guide member 30, facing the first guide member 20, may be formed as a plane parallel to a first surface 50a of the second bending member 50 described below.

The second guide member 30 may be disposed to be movable in the first direction (the Z-axis direction) and may be disposed such that a lower end thereof faces the first surface of the sealing portion 3. Therefore, the lower end portion of the second guide member 30 may be formed to have a thickness corresponding to a gap between the second guide member 30 and the cell body 2.

As the second guide member 30 moves, the lower end of the second guide member 30 may come into contact with the sealing portion 3. Similar to the third frame 25, the second guide member 30 may be formed to have a wedge shape with a thickness decreasing toward the lower end. Therefore, the lower end of the second guide member 30 may be formed to be sharp.

The first surface 30a of the second guide member 30, facing the first guide member 20, may be formed as a flat surface. For example, the first surface of the second guide member 30 may be disposed parallel to a plane defined by the first direction (the Z-axis direction) and the third direction (the X-axis direction).

To move the second guide member 30, the second guide member 30 may be connected to a third moving device 31. The third movement device 31 may be any known device capable of linearly reciprocating the second guide member 30 in the first direction (the Z-axis direction), such as a linear motor, hydraulic/pneumatic cylinder, or robot arm.

During the folding process, the second guide member 30 may move in the first direction (the Z-axis direction) and come into contact with the sealing portion 3. Here, the lower end of the second guide member 30 may contact the sealing portion 3 and define the second folding line F2. For example, a contact line in which the lower end of the second guide member 30 contacts the sealing portion 3 may be defined as the second folding line F2.

The second bending member 50 may be disposed on one surface of the battery cell 1 in which the sealing portion 3 is formed and may be disposed to be movable in both the first direction (the Z-axis direction) and the second direction (the Y-axis direction). To this end, the second bending member 50 may be connected to a fourth moving device 51. The fourth moving device 51 may be any known device capable of linearly moving the second bending member in the first direction (the Z-axis direction) and the second direction (the Y-axis direction), such as a linear motor, hydraulic/pneumatic cylinder, or robot arm.

The second bending member 50 may be formed to have a block shape and include a first surface 50a disposed parallel to the first direction (the Z-axis direction) and a second surface 50b and a third surface 50c extending from the first surface 50a and disposed parallel to the second direction (the Y-axis direction). The first surface 50a, the second surface 50b, and the third surface 50c of the second bending member 50 may be formed as flat planes. Furthermore, a chamfered surface 50d may be formed at the corner portion at which the first surface 50a and second surface 50b meet, and the corner portion 50e at which the first surface 50a and third surface 50c meet may be formed as a chamfered surface or a curved surface. Here, the chamfered surface may refer to an inclined surface obtained by processing the corner of the second bending member 50 not to be sharp.

The first surface 50a, facing the sealing portion 3, may be disposed parallel to a plane defined by the first direction (the Z-axis direction) and the third direction (the X-axis direction). The first surface 50a may refer to a left surface of the second bending member 50 in FIG. 3 and may be defined as a surface facing the first surface 30a of the second guide member 30 and the second surface 40b of the first bending member 40 in the folding process. For example, the first surface 50a of the second bending member 50 may be a plane disposed parallel to the first surface 30a of the second guide member 30 and the second surface 40b of the first bending member 40.

The second bending member 50 may include a heat source applying heat to the sealing portion 3. For example, a third heat source 55 may be disposed on the first surface 50a of the second bending member 50. The second heat source 55 may heat a region in the vicinity of the first surface 50a of the second bending member 50, and to this end, the second heat source 55 may include a heat-generating heater.

The second surface 50b and the third surface 50c of the second bending member 50 are surfaces, perpendicular to the first surface 50a. As illustrated in FIG. 3, the second surface 50b may refer to the lower surface of the second bending member 50, and the third surface 50c may refer to the upper surface of the second bending member 50. Furthermore, the second surface 50b of the second bending member 50 may be formed as a plane, parallel to the first surface 40a of the first bending member 40.

The chamfered surface 50d of the second bending member 50 may face one surface of the third frame 25 of the first guide member 20 described above in the folding process. Therefore, an inclination angle of the chamfered surface 50d with respect to the second direction may be equal to or greater than an inclination angle of the third frame 25.

Furthermore, to prevent damage to the sealing portion 3 due to the second bending member 50 when the second bending member 50 bends the sealing portion 3, the corner portion at which the first surface 50a and the third surface 50c of the second bending member 50 meet may be formed as the curved surface 50e or the chamfered surface 50d.

The second bending member 50 may contact the sealing portion 3 and bent the sealing portion 3. For example, the second bending member 50 may move in the first direction (the Z-axis direction), the thickness direction of the battery cell 1, to firstly bend the sealing portion 3 and then move in the second direction (the Y-axis direction), the surface direction of the battery cell 1, to secondly bend the sealing portion 3. Accordingly, the second bending member 50 may bend the sealing portion 3 by 180 degrees with respect to the first folding line F1.

Furthermore, the second bending member 50 may apply heat to the bending portion of the sealing portion 3 to thermally press the sealing portion 3. For example, the second bending member 50 may thermally press the sealing portion 3 from both sides of the sealing portion 3 together with the first bending member 40 or the second guide member 30.

Meanwhile, the folding apparatus 10 of the present embodiment may further include a cooling device 60. The cooling device 60 may be provided to fix the sealing portion 3 in a folded form and, to this end, the cooling device 60 may spray cold air onto the sealing portion 3. Therefore, the cooling device 60 of the present embodiment may be any known device, as long as it may supply cold air to the sealing portion 3.

Next, a folding method using the folding apparatus 10 of the present embodiment will be described.

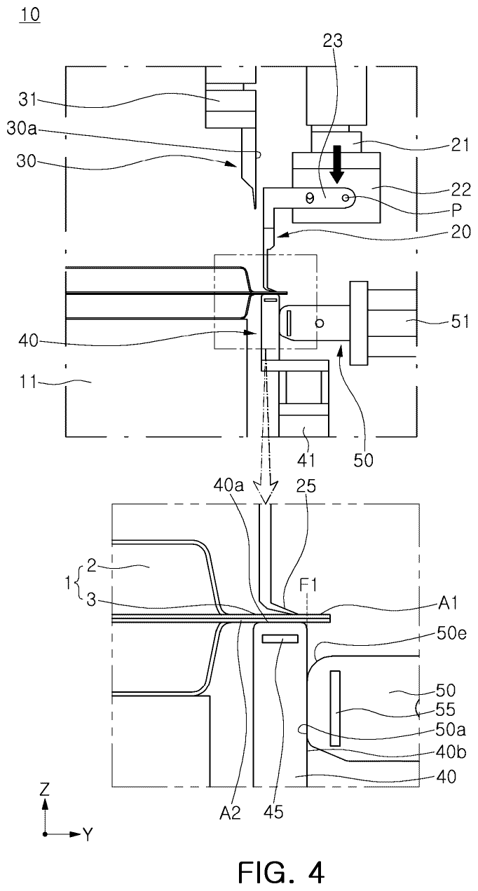

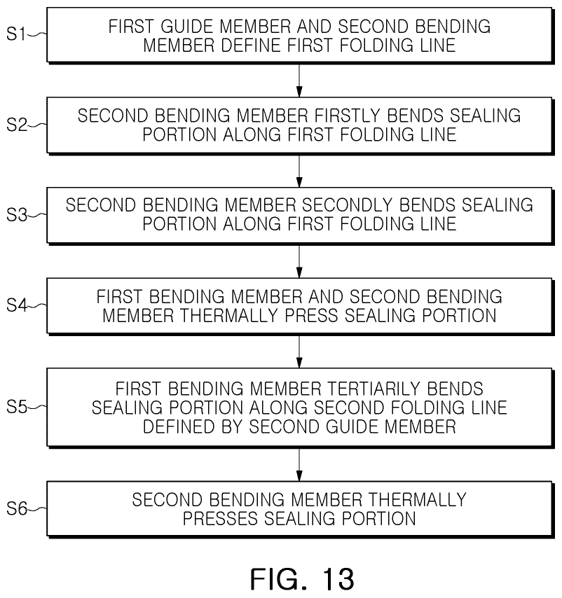

FIGS. 4 to 12 are diagrams illustrating a folding method using the folding apparatus illustrated in FIG. 3 and FIG. 13 is a flowchart illustrating a folding method using the folding apparatus illustrated in FIG. 3.

Referring to FIGS. 4 to 13, a battery cell folding method according to the present embodiment may include an first operation (S1) in which the first guide member 20 presses the first surface of the sealing portion 3 of the battery cell 1 and the first bending member 40 presses the second surface of the sealing portion 3 to define the first folding line F1, a first bending operation (S2) in which the second bending member 50 moves in the first direction (the Z-axis direction), the thickness direction of the battery cell 1, and bends the sealing portion 3 along the first folding line F1, a second bending operation (S3) in which the second bending member 50 moves in the second direction (the Y-axis direction), the surface direction of the battery cell 1, and bends the sealing portion 3 along the first folding line F1, and a third bending operation (S5) in which the first bending member 40 moves in the first direction (the Z-axis direction) along the second folding line F2 defined by the second guide member 30 to bend the sealing portion 3.

Here, the first bending operation may be an operation in which the sealing portion 3 is bent by 90 degrees relative to the initial state thereof and the second bending operation may be an operation in which the sealing portion 3 is bent by 180 degrees relative to the initial state thereof.

Furthermore, after the second bending operation, the method may further include an operation (S4) in which the first bending member 40 and the second bending member 50 thermally press the sealing portion 3 in the first direction (the Z-axis direction). After the third bending operation, the method may further include an operation (S6) in which the second bending member 50 thermally press the sealing portion 3 in the second direction (the Y-axis direction).

More specifically, the folding method of the present embodiment may first perform the operation (S1) of defining the first folding line F1. In this operation, the first guide member 20 and the first bending member 40 may move toward the sealing portion 3 to press the sealing portion 3. As a result, as illustrated in FIG. 4, the sealing portion 3 disposed between the first guide member 20 and the first bending member 40 may be engaged by the first guide member 20 and the first bending member 40 and restrained from moving.

The first folding line F1 may be defined as a line in which the sealing portion 3 intersects the plane formed by the lower end of the first guide member 20 and the second surface of the first bending member 40.

With the first folding line F1 defined, the sealing portion 3 may be divided into a first region A1 and a second region A2 illustrated in FIG. 2 with respect to the first folding line F1. The first region A1 may refer to an outer portion of the first folding line F1 exposed to the outside of the first bending member 40 and the second region A2 may refer to an inner portion of the first folding line F1 disposed between the cell body 2 and the first folding line F1 and at least partially contacting the first bending member 40.

The first bending operation (S2) may include an operation in which the second bending member 50 is disposed in close contact with the second surface of the first bending member 40 and an operation in which the second bending member 50 rises in the first direction (the Z-axis direction) and bends the sealing portion 3.

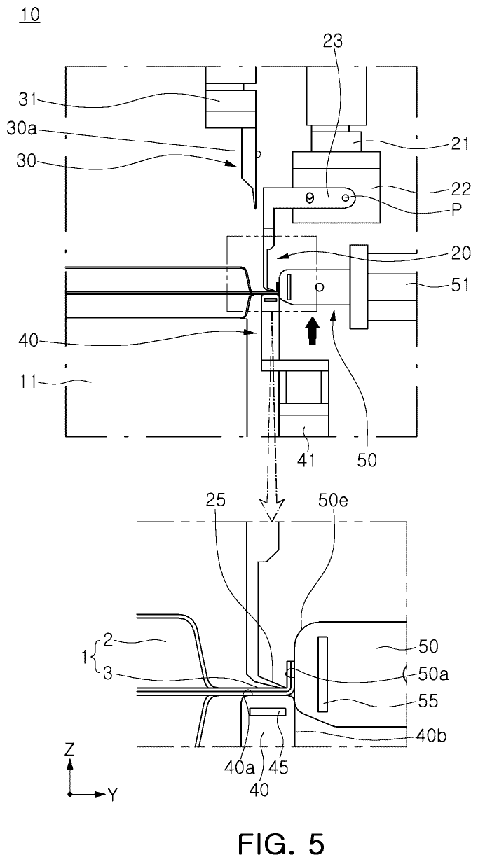

When the second bending member 50 is disposed in close contact with the second surface 40b of the first bending member 40, the second bending member 50 may press the first region A1 of the sealing portion 3, while rising in the first direction (the Z-axis direction), while in close contact with the second surface 40b of the first bending member 40. As such, as illustrated in FIG. 5, the first region A1 of the sealing portion 3 may be folded, while supporting the lower end of the first guide member 20.

In this operation, the second bending member 50 moves only in the first direction (the Z-axis direction) and presses the sealing portion 3. Therefore, once the movement of the second bending member 50 is complete, the first region A1 may be folded at approximately 90 degrees with respect to the second region A2.

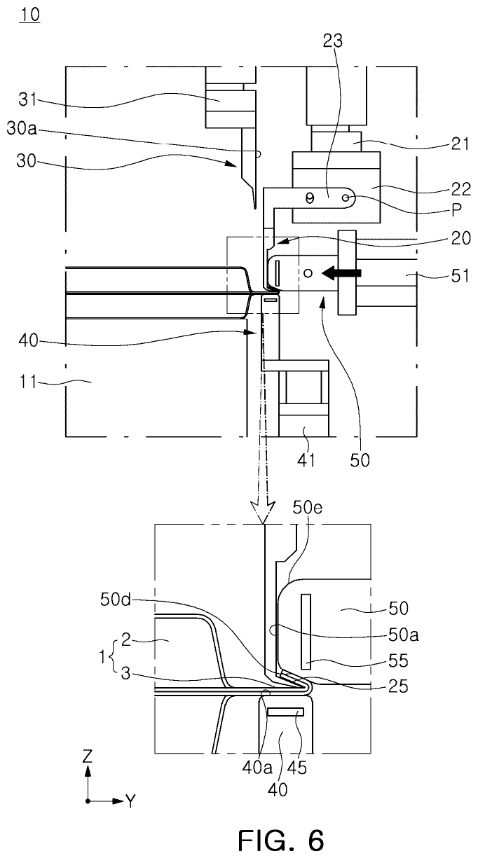

Subsequently, the second bending operation (S3) may be performed. During the second bending operation, the second bending member 50 may move in the second direction (the Y-axis direction), and in this process, as illustrated in FIG. 6, the first region A1 and the second region A2 may form an acute angle, the first guide member 20 may return to the initial position thereof, and the first region A1 may be brought into close contact with the second region A2.

As the second bending member 50 moves in the second direction (the Y-axis direction) toward the cell body 2, the first region A1 and the second region A2 may form an acute angle. In this operation, the first region A1 may be pressed by the second bending member 50 so as to be further bent, thereby forming an acute angle with the second region A2.

In this operation, the first region A1 may be supported by an inclined surface formed by the third frame 25 of the first guide member 20. Furthermore, the first region A1 may be maintained in a bent state by one surface of the third frame 25 and the chamfered surface 50d of the second bending member 50.

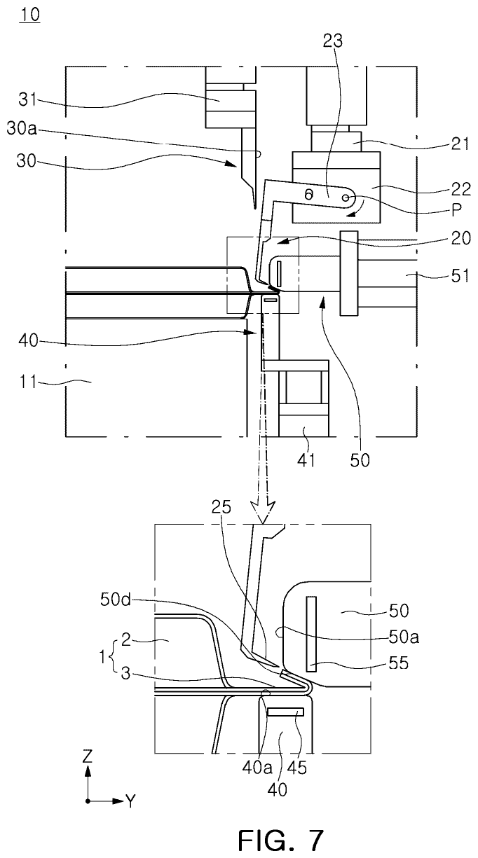

Next, an operation may be performed in which the first guide member 20 returns to the initial position thereof. When the second bending member 50 moves in the second direction (the Y-axis direction) so that the first region A1 forms an acute angle with the second region A2, the first guide member 20 may rotate to be separated from the sealing portion 3, as illustrated in FIG. 7.

The first guide member 20 may rotate about the rotational axis P. The first guide member 20 may rotate in a direction in which the third frame 25 becomes away from the first region A1, i.e., in a direction in which the third frame 25 is closer to the cell body 2. Accordingly, the third frame 25 may be separated from the first region A1.

The first guide member 20, separated from the first region A1, may move linearly in the first direction (the Z-axis direction) and return to the initial position thereof. As the first guide member 20 returns to the initial position thereof, the second bending member 50 may continue to move in the second direction (the Y-axis direction) without being interfered with the first guide member 20.

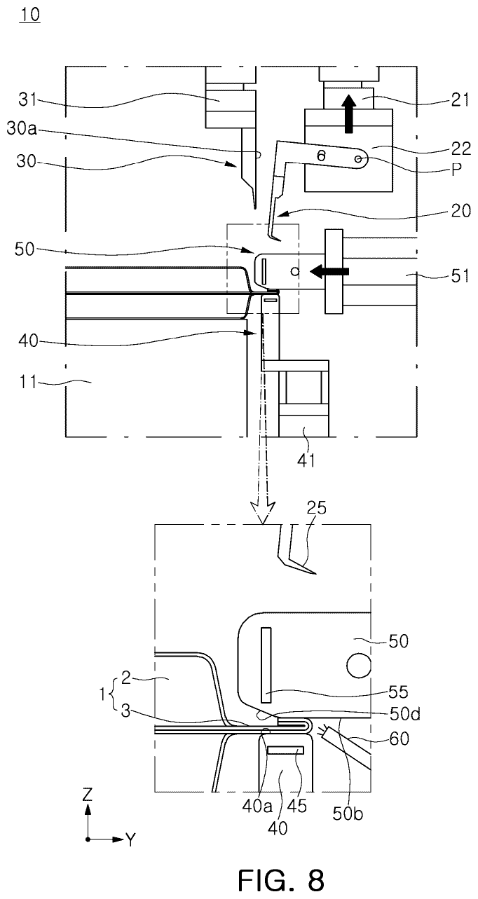

Therefore, as illustrated in FIG. 8, the second bending member 50 may move in the second direction (the Y-axis direction) to bring the first region A1 into close contact with the second region A2. This operation may include an operation (S4) in which the first bending member 40 and the second bending member 50 thermally press the sealing portion 3. While pressing the sealing portion 3, the first bending member 40 and the second bending member 50 may simultaneously apply heat to the sealing portion 3 via the first heat source 45 and the second heat source 55, and as a result, the sealing portion 3 may be fixed in a state in which the first region A1 and the second region A2 overlap each other.

Meanwhile, an operation of cooling the first folding line F1 may be further performed so that the first region A1 remains folded. This operation may be performed rapidly after the completion of the thermally pressing process described above. In this operation, the cooling device 60 may spray cold air along the first folding line F1 and, if necessary, also spray cold air into the first region A1.

Subsequently, the third bending operation (S5) may be performed. This operation may include an operation in which the second bending member 50 moves in the second direction (the Y-axis direction) away from the cell body 2, an operation in which the second guide member 30 is lowered to define the second folding line F2, an operation in which the first bending member 40 moves in the first direction (the Z-axis direction) to bend the sealing portion 3, and an operation in which the second bending member 50 thermally press the third region A3.

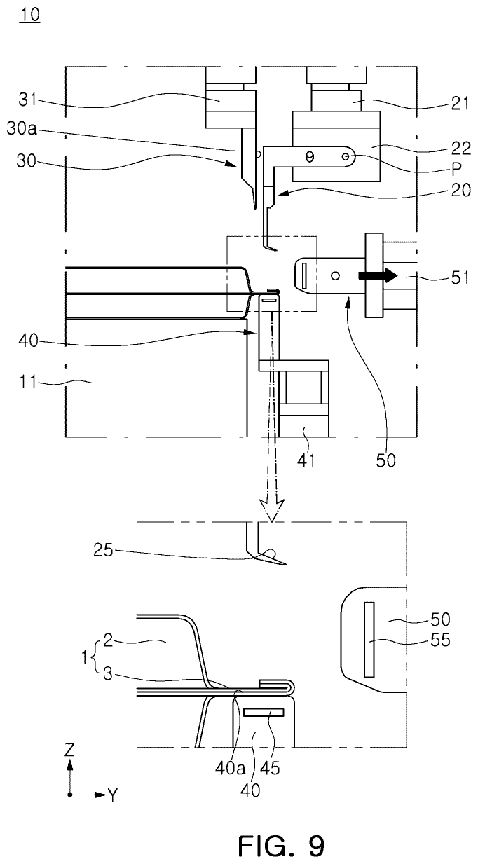

As illustrated in FIG. 9, the second bending member 50 may move linearly in the second direction (the Y-axis direction) away from the cell body 2. Accordingly, the second bending member 50 may be disposed at a position spaced apart from the battery cell 1 at a predetermined distance.

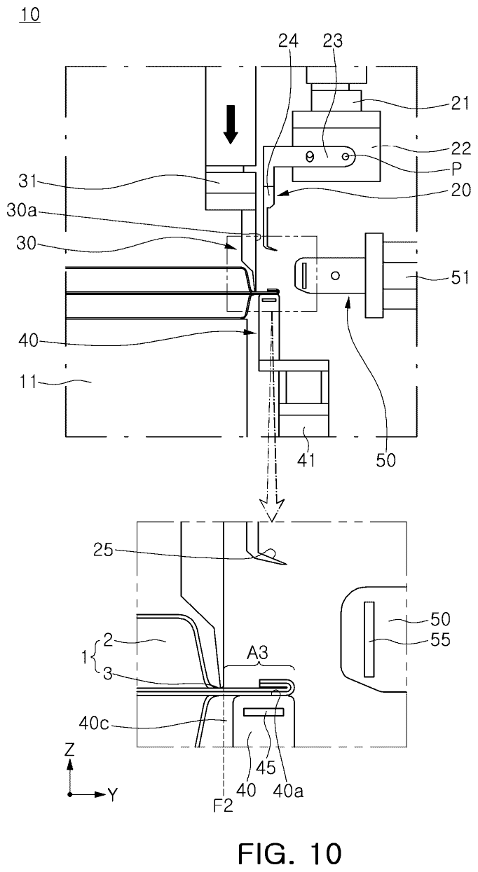

During the operation of defining the second folding line F2, the second guide member 30 may be lowered to contact the sealing portion 3. During this process, as illustrated in FIG. 10, the lower end of the second guide member 30 may contact a portion of the second region A2 of the sealing portion 3 adjacent to the cell body 2, thereby guiding the second folding line F2.

Meanwhile, in FIGS. 10 to 12, the second folding line F2 and the first bending member 40 are illustrated as being separated. However, this is because the thickness of the sealing portion 3 is enlarged for ease of understanding. In reality, since the sealing portion 3 is sufficiently thin, the third surface of the first bending member 40 may overlap or be disposed sufficiently adjacent to the second folding line F2.

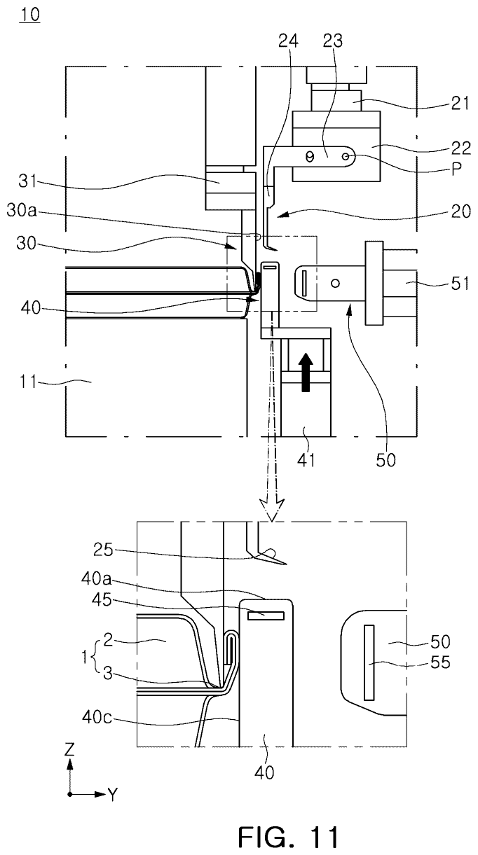

Subsequently, as the first bending member 40 rises, the sealing portion 3 may be bent along the second folding line F2. As illustrated in FIG. 11, the first bending member 40 may press the third region (A3 of FIG. 2) of the sealing portion 3 located outside the second folding line F2, while moving in the first direction (the Z-axis direction), and accordingly, the third region A3 of the sealing portion 3 may be folded along the second folding line F2 supported by the lower end of the second guide member 30. In an embodiment, the third region A3 may be folded by 90 degrees along the second folding line F2. However, the present disclosure is not limited thereto.

Subsequently, the operation (S6) in which the second bending member 50 thermally press the third region A3 may be performed.

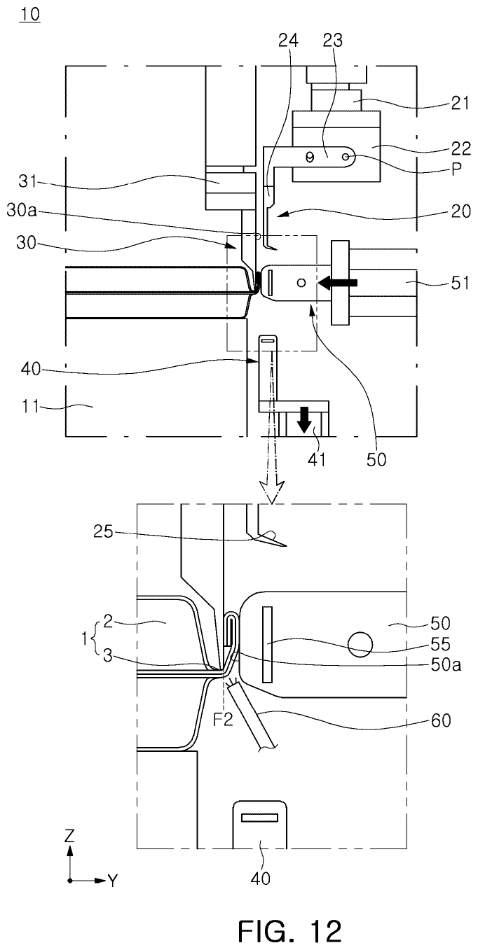

In this operation, the first bending member 40 is lowered and returns to the initial position thereof, and as illustrated in FIG. 12, the second bending member 50 may move toward the cell body 2 so that the first surface thereof may contact the third region A3. Here, the second bending member 50 may contact the third region A3 before the third region A3 returns to its original position due to a springback phenomenon.

As the second bending member 50 moves in the second direction (the Y-axis direction), the third region A3 may be disposed between the first surface of the second guide member 30 and the first surface of the second bending member 50. The third region A3 may be pressed on both sides by the second guide member 30 and the second bending member 50. During this process, the second bending member 50 may apply heat to the third region A3 and the second folding line F2. Thus, the third region A3 may be fixed in a 90-degree folded state.

In FIG. 12, the second folding line F2 and the second bending member 50 are illustrated as being separated from each other. However, this is because the thickness of the sealing portion 3 is enlarged for ease of understanding. In reality, since the sealing portion 3 is sufficiently thin, the second folding line F2 may also be sufficiently pressed by the second bending member 50.

Meanwhile, to ensure that the third region A3 remains folded, an operation of cooling the second folding line F2 may be further performed. This operation may be performed rapidly after the process of applying heat to the second folding line F2 via the second bending member 50 is completed. In this operation, the cooling device 60 may spray cold air along the second folding line F2 and, if necessary, also spray cold air to the third region A3.

In the folding method of the present embodiment described above, both 180-degree folding of the first region A1 and 90-degree folding of the third region A3 may be performed using the single folding apparatus 10. Accordingly, the folding process may be simplified and the space occupied by the folding apparatus 10 may be minimized.

Furthermore, the folding method of the present embodiment allows the first guide member 20 to rotate and be separated from the sealing portion 3. Accordingly, damage to the sealing portion 3 caused by the first guide member 20 may be minimized.

Hereinafter, embodiments of the present disclosure are further described with reference to specific experimental examples. The examples and comparative examples included in the experimental examples are merely illustrative of the present disclosure and do not limit the scope of the appended claims. It will be apparent to those skilled in the art that various modifications and variations to the examples may be made within the scope and technical spirit of the present disclosure, and such modifications and variations are also within the scope of the appended claims.

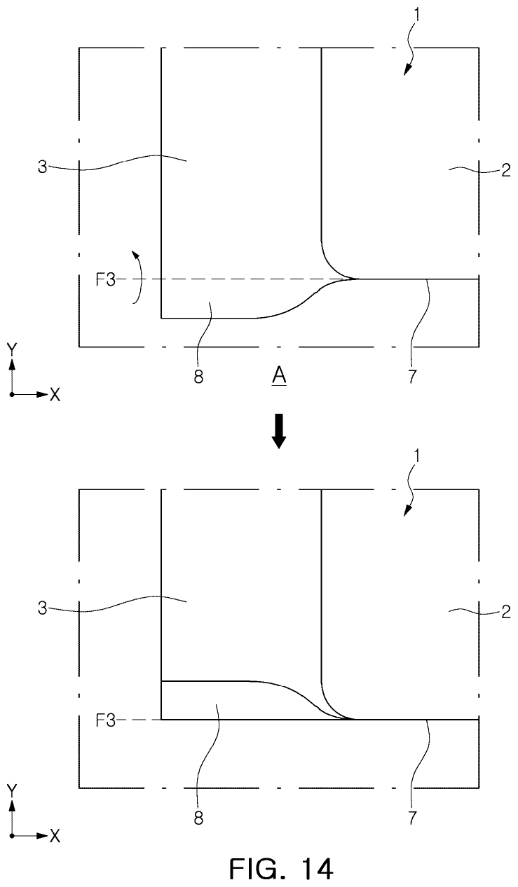

FIG. 14 is an enlarged view of portion A of FIG. 1.

Referring to FIG. 14, the battery cell 1 of the present embodiment may be formed by folding a single sheet of outer casing to cover the electrode assembly 6 and by sealing three sides thereof. In this case, due to a difference in thickness between the cell body 2 accommodating the electrode assembly 6 and the sealing portion 3, a portion protruding further outwardly (e.g., in the −Y-axis direction in FIG. 14) of the folding surface 7 of the outer casing may be formed. For example, as illustrated in FIG. 3, a shark fin 8, a portion protruding in an outward direction of the folding surface 7, may be formed in a portion extending from the sealing portion 3 to the folding surface 7. The shark fin is also referred to as a delta fin or bat ear, but in the present embodiment, it is referred to as a shark fin and described.

The shark fin 8, protruding in the outward direction of the folding surface 7, unnecessarily expands the overall external shape of the battery cell 1, which may result in a reduction of energy density or cooling efficiency of a battery module or battery pack in which battery cells are packaged.

Therefore, the folding apparatus 10 according to the present disclosure may fold the shark fin 8, a portion of the edge of the battery cell 1, so that the shark fin 8 does not protrude outwardly.

Folding the shark fin 8 may be performed similarly to the process of folding the sealing portion 3 along the second folding line F2 in the embodiment described above.

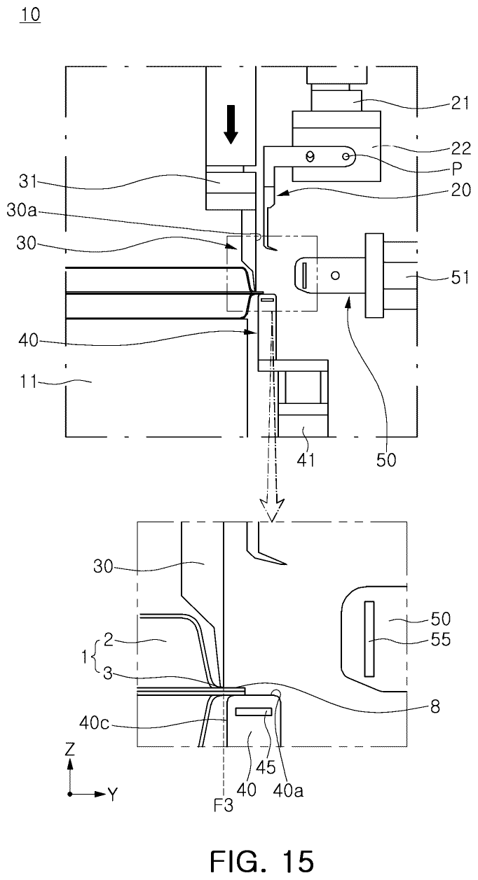

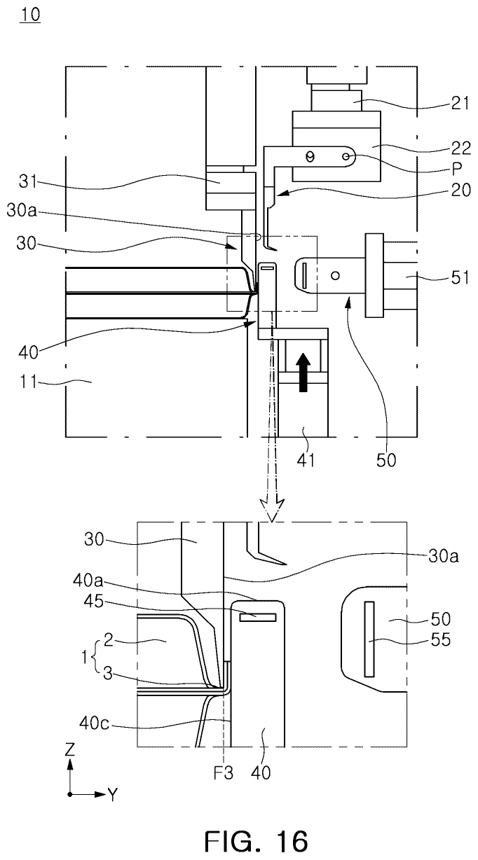

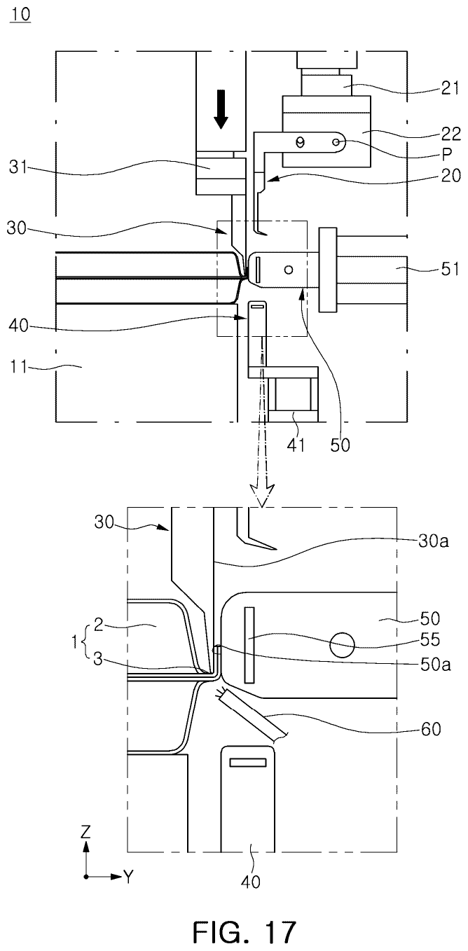

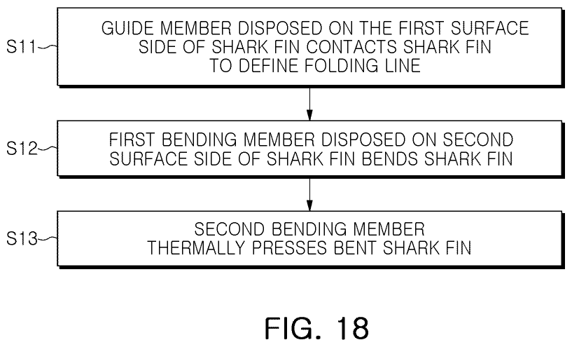

FIGS. 15 to 17 are diagrams illustrating a shark fin folding method using the folding apparatus illustrated in FIG. 3 and FIG. 18 is a flowchart illustrating a shark fin folding method using the folding apparatus illustrated in FIG. 3.

Referring to FIGS. 15 to 18, the battery cell folding method of the present embodiment may include, as a method of folding a shark fin of a battery cell, an operation (S11) in which the second guide member 30 disposed on the first surface of the shark fin contacts the shark fin to define a folding line, an operation (S12) in which the first bending member 40 disposed on the second surface of the shark fin moves in the first direction (the Z-axis direction), the thickness direction of the battery cell 1, to bend the shark fin, and an operation (S13) in which the second bending member 50 moves in the second direction (the Y-axis direction), the surface direction of the battery cell 1, to thermally press the bent shark fin.

In the operation (S11) of defining the folding line, the second guide member 30 may be lowered to contact the shark fin 8. During this process, the lower end of the second guide member 30 may contact the shark fin 8 and guide the third folding line F3.

Subsequently, an operation in which the shark fin 8 is bent, while the first bending member 40 rises, may be performed. While, moving upwardly in the first direction (the Z-axis direction), the first bending member 40 may press a portion of the shark fin 8 located outside the third folding line F3. Accordingly, the shark fin 8 may be folded along the third folding line F3 supported by the lower end of the second guide member 30.

Subsequently, an operation in which the second bending member 50 thermally press the shark fin 8 may be performed.

In this operation, the first bending member 40 may be lowered and return to the initial position thereof and the second bending member 50 may move toward the cell body 2 so that the first surface thereof may contact the shark fin 8. Here, the second bending member 50 may contact the shark fin 8 before the shark fin 8 returns to its original position due to a springback phenomenon.

As the second bending member 50 moves in the second direction (the Y-axis direction), the shark fin 8 may be disposed between the first surface 30a of the second guide member 30 and the first surface of the second bending member 50. The shark fin 8 may be pressed on both sides by the second guide member 30 and the second bending member 50, and in this process, the second bending member 50 may apply heat to the shark fin 8 and the third folding line F3. Accordingly, the shark fin 8 may be fixed in a 90-degree bent state.

According to an embodiment of the present disclosure, the speed of folding the sealing portion of the pouch-type battery cell may be improved, thereby reducing battery cell manufacturing time and increasing battery cell production.

Although the embodiments of the present disclosure have been described above, the scope of the present disclosure is not limited thereto and it will be apparent to those skilled in the art that various modifications and variations may be made within the scope not departing from the technical idea of the present disclosure described in the claims.

For example, the present disclosure may be implemented by deleting some of the components in the above-described embodiments and the respective embodiments may be implemented in combination with each other.

What is claimed is:

1. A folding processing apparatus for a battery cell, the folding processing apparatus comprising:
a first guide member defining a first folding line on a first surface of a sealing portion of a battery cell;
a second guide member defining a second folding line on the first surface of the sealing portion;
a first bending member defining the first folding line on a second surface of the sealing portion and bending the sealing portion along the second folding line; and
a second bending member bending the sealing portion by 180 degrees along the first folding line.

2. The folding processing apparatus of claim 1, wherein the second bending member firstly bends the sealing portion, while moving in a first direction, a thickness direction of the battery cell, and secondly bends the sealing portion, while moving in a second direction, a surface direction of the battery cell.

3. The folding processing apparatus of claim 2, wherein the first bending member bends the sealing portion, while moving in the first direction.

4. The folding processing apparatus of claim 3, wherein the first guide member is disposed to be movable linearly in the first direction and to be rotatable, in a third direction, orthogonal to the first direction and the second direction, as an axis.

5. The folding processing apparatus of claim 4, wherein
the first guide member includes:
a first frame disposed parallel to the second direction;
a second frame extending from the first frame toward the battery cell; and
a third frame extending from the second frame to form an acute angle with the sealing portion, an end of the third frame contacting the sealing portion to define the first folding line.

6. The folding processing apparatus of claim 5, wherein a rotational axis of the first guide member is formed in the first frame.

7. The folding processing apparatus of claim 1, wherein the first bending member and the second bending member respectively include a heat source applying heat to the sealing portion.

8. The folding processing apparatus of claim 5, wherein
the second bending member includes:
a first surface disposed parallel to the first direction; and
a second surface and a third surface extending from the first surface and disposed parallel to the second direction,
wherein the first surface, the second surface, and the third surface are formed as flat planes, and
a chamfered surface is formed at a corner portion at which the first surface and the second surface meet.

9. The folding processing apparatus of claim 8, wherein an inclination angle of the chamfered surface with respect to the second direction is formed to be equal to or greater than an inclination angle of the third frame.

10. The folding processing apparatus of claim 8, wherein a corner portion at which the first surface and the third surface meet is formed as a chamfered surface or a curved surface.

11. The folding processing apparatus of claim 8, wherein the second guide member is disposed between the first guide member and a cell body of the battery cell, and a first surface of the second guide member facing the first guide member is formed as a plane, parallel to the first surface of the second bending member.

12. A folding processing apparatus for a battery cell, the folding processing apparatus comprising:
a first guide member disposed to be linearly and rotatably movable and pressing a first folding line of a sealing portion of a battery cell on a first surface of the sealing portion;
a first bending member disposed on a second surface of the sealing portion and supporting the sealing portion; and
a second bending member firstly bending the sealing portion, while moving in a first direction, a thickness direction of the battery cell, and secondly bending the sealing portion, while moving in a second direction, a surface direction of the battery cell,
wherein the first guide member supports the first folding line, while the second bending member moves in the first direction, and
when the second bending member moves in the second direction, the first guide member rotates to be separated from the sealing portion.

13. The folding processing apparatus of claim 12, further comprising:
a second guide member pressing a second folding line of the sealing portion on the first surface of the sealing portion,
wherein the first bending member bends the sealing portion along the second folding line, while moving in the first direction.

14. A battery cell manufacturing method comprising:
a first operation in which a first guide member presses a first surface of a sealing portion of a battery cell and a first bending member presses a second surface of the sealing portion to define a first folding line;
a first bending operation in which a second bending member bends the sealing portion along the first folding line, while moving in a first direction, a thickness direction of the battery cell;
a second bending operation in which the second bending member bends the sealing portion along the first folding line, while moving in a second direction, a surface direction of the battery cell; and
a third bending operation in which the first bending member bends the sealing portion, while moving in the first direction along a second folding line defined by a second guide member.

15. The battery cell manufacturing method of claim 14, further comprising: after the second bending operation, an operation in which the first bending member and the second bending member thermally press the sealing portion in the first direction.

16. The battery cell manufacturing method of claim 14, further comprising: after the third bending operation, an operation in which the second bending member thermally presses the sealing portion in the second direction.

17. The battery cell manufacturing method of claim 14, wherein, in the second bending operation, when the second bending member moves in the second direction, the first guide member rotates to be separated from the sealing portion.

18. The battery cell manufacturing method of claim 14, wherein
the first bending operation is an operation of bending the sealing portion by 90 degrees from an initial state and
the second bending operation is an operation of bending the sealing portion by 180 degrees from the initial state.
